(19) United States
(12) Patent Application Publication
(10) Pub. No.: US 2008/0222510 A1
(43) Pub. Date: Sep. 11, 2008

(54) METHOD AND SYSTEM FOR GENERATING A HISTORY LOG ASSOCIATED WITH A SPREADSHEET

(76) Inventors: Huy Nguyen, Cupertino, CA (US); Gavin Harvett, Mountain View, CA (US); George Langan, Park City, UT (US)

Correspondence Address: HAHN AND MOODLEY, LLP, P.O. BOX 52050, MINNEAPOLIS, MN, 55402, US

(21) Appl. No.: 11/683,740

(22) Filed: Mar. 8, 2007

(51) Int. Cl. G06F 17/00; G06F 3/00

(52) U.S. Cl. 715/212; 715/704; 707/104.1

(57) ABSTRACT

In one embodiment, the invention provides a method comprising monitoring for activity relating to a spreadsheet; for each activity detected, generating an entry in a history log for the spreadsheet.

### FIELD OF THE INVENTION

Embodiments of the invention relate to electronic spreadsheets.

### BACKGROUND

The use of electronic spreadsheets (hereinafter “spreadsheets”) is widespread. Factors that may explain the widespread use include the ease at which data can be entered, modified, analyzed, and visualized. Increasingly, spreadsheets are also used for collaboration. For example, spreadsheets may be passed between several collaborators as email attachments. Alternatively, the collaborators may access one or more spreadsheets from a common repository. The inventors have found that even with the most rudimentary level of collaboration and sometimes even where there is no collaboration per se, but there are multiple revisions to a spreadsheet, it is difficult to track the revisions. It is also difficult to track the history of collaboration on a spreadsheet.

### BRIEF DESCRIPTION OF THE DRAWINGS

FIG. 1 illustrates the architecture for a spreadsheet service, in accordance with one embodiment of the invention;

FIG. 2 illustrates spreadsheet decomposition, conceptually, in accordance with one embodiment of the invention;

FIG. 3 shows a flowchart for spreadsheet decomposition, in accordance with one embodiment of the invention;

FIG. 4 shows a flowchart for a spreadsheet convert function, in accordance with one embodiment of the invention;

FIGS. 5A to 5F show screenshots of a graphical user-interface (GUI) for facilitating a convert function to convert a source spreadsheet into a target spreadsheet; in accordance with one embodiment of the invention;

FIGS. 6A to 6B illustrate the user steps for using the convert function, in accordance with one embodiment of the invention;

FIG. 7 shows a flowchart of user steps when using the compare function to compare two spreadsheets, in accordance with one embodiment of the invention;

FIGS. 8A to 8D show screenshots of a GUI corresponding to the steps of FIG. 7; in accordance with one embodiment of the invention;

FIG. 9 shows a flowchart of operations performed by the compare function; in accordance with one embodiment of the invention;

FIG. 10 shows a flowchart of user steps when using a history function; in accordance with one embodiment of the invention;

FIG. 11 shows a screenshot of a GUI showing a history log; in accordance with one embodiment of the invention;

FIG. 12 shows a flowchart of operations performed by the history function; in accordance with one embodiment of the invention;

FIG. 13 shows a screenshot of a GUI for viewing the history associated with a user-specified range of cells; in accordance with one embodiment of the invention; and

FIG. 14 shows a block diagram of hardware that may be used to implement a network server, in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, embodiments of the invention describe an architecture for a spreadsheet service that allows a user to store a spreadsheet in a database and to perform one or more predefined operations on the spreadsheet. In one embodiment the predefined operations comprise a transformation of data in a spreadsheet in accordance with a user-defined transformation, and a comparison between two spreadsheets. Advantageously, the spreadsheet service and the database may be implemented online.

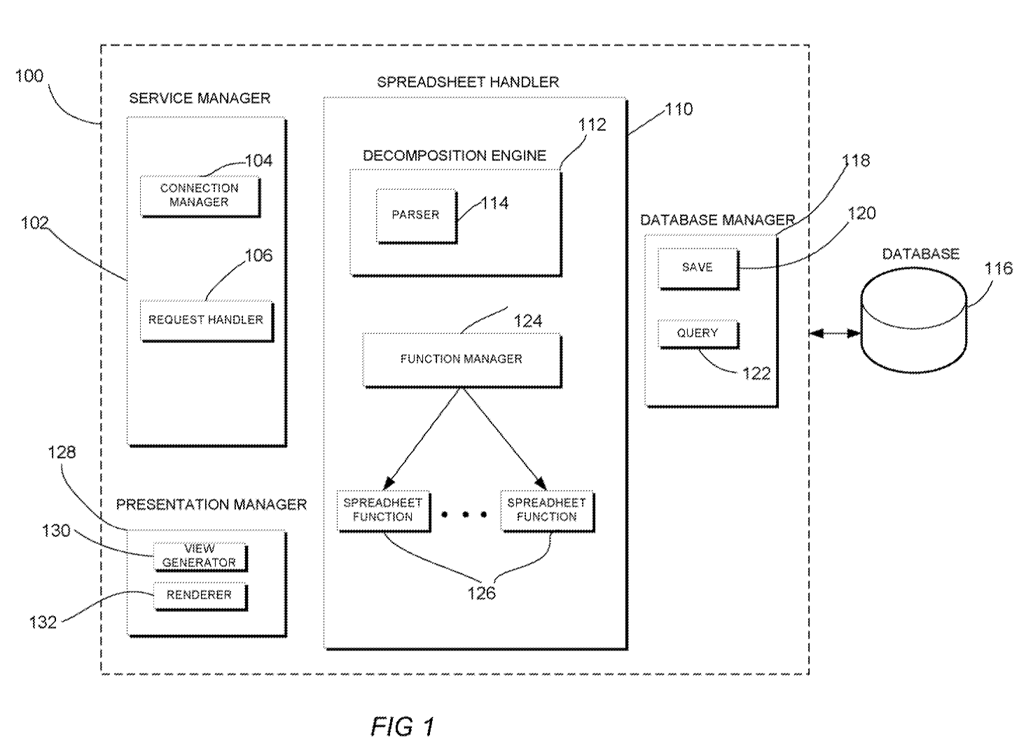

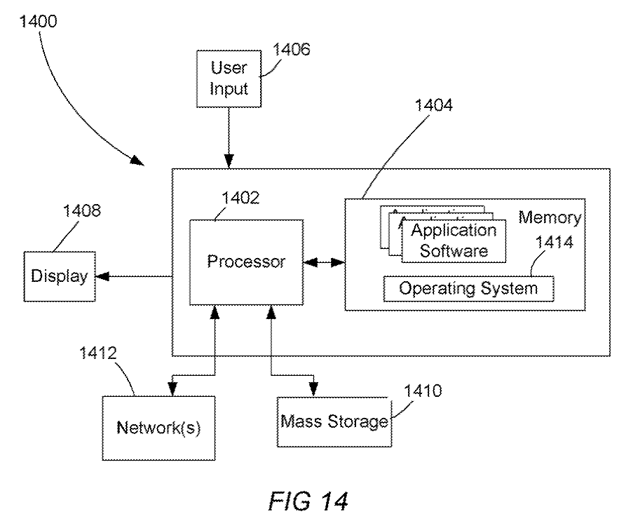

FIG. 1 shows an exemplary architecture 100 for a web-based spreadsheet service, in accordance with one embodiment of the invention. The architecture 100 may be implemented as a single or distributed network server computer. Exemplary hardware for such a network server computer is illustrated in FIG. 14 of the drawings and described later.

As will be seen in FIG. 1, the architecture 100 comprises a service manager 102. The service manager 102 includes a connection manager 104 that implements functions to allow a user to connect to the web-based spreadsheet service, using, e.g. web communications protocols such as the Hypertext Transfer Protocol (HTTP) over the Transmission Control Protocol (TCP/IP) or HTTPS (Hypertext Transfer Protocol over the Secure Socket Layer (SSL). For example the connection manager 104 may implement a Create Account function to enable a user to create an account with the spreadsheet service. In accordance with different embodiments of the invention, there may be a “free account” and a subscription-based account. The Create Account function may allow a user to create login information such as a username and password. In one embodiment, the connection manager 104 may implement a Login function to allow a user to login to the service. The Login function may implement an Authentication function to authenticate a user of the service. Thus, the Authentication function may require a user to pass an authentication challenge i.e. supply a correct user name and password before access to the service is granted to the user. In one embodiment, the connection manager 104 may also implement session management functions such as a function to set cookies to customize a users experience.

Once a user has been authenticated, requests made by the user are handled by a request handier 106, as will be explained in detail later.

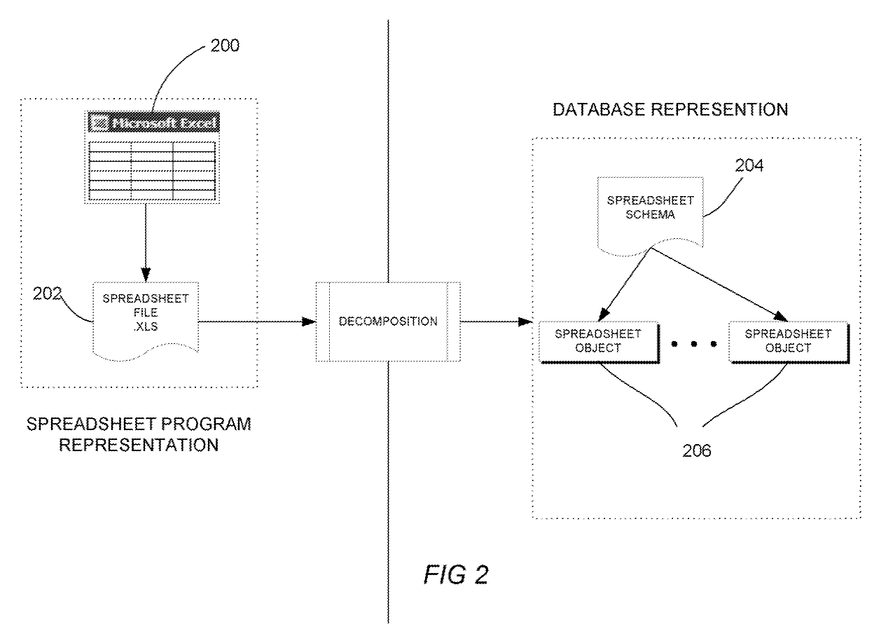

The architecture 100 also includes a spreadsheet handler 110 that implements functionality to perform a plurality of predefined operations on a spreadsheet. As will be seen, the spreadsheet manager 110 includes a decomposition engine 112, the purpose of which is to decompose a spreadsheet into its constituent spreadsheet objects. Conceptually, the decomposition of a spreadsheet in one embodiment of the invention may be visualized as in FIG. 2 of the drawings. Referring to FIG. 2, a spreadsheet file 202 corresponding to a spreadsheet 200 is decomposed into a spreadsheet schema 204 and a plurality of spreadsheet objects 206. The spreadsheet schema 204 represents a structural view of the spreadsheet 200 in terms of its constituent spreadsheet objects. Thus, the spreadsheet schema 204 serves as a map to recompose the spreadsheet 202 base on its constituent spreadsheet objects. As used herein, the term “spreadsheet object” refers to the constituent elements of building blocks of a spreadsheet. Typical spreadsheet objects include cells, cell attributes, e.g. formatting, data, formulas, macros, owner information, etc. Referring again to FIG. 2, the spreadsheet file 200 is in a file format that is readable by a spreadsheet program. For example, the file 200 may be in the .xls format which is readable by the Excel™ spreadsheet program. Without the decomposition operation of the present invention, the file 200 is unreadable and is treated as a Binary Large Object (BLOB) from the point of view of a database.

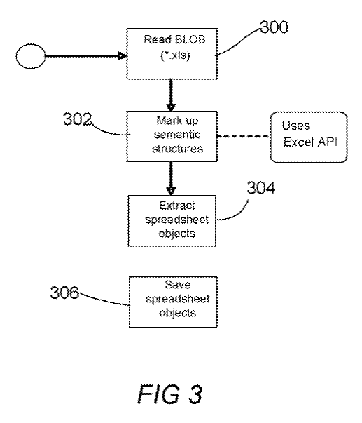

FIG. 3 shows the operations performed by the decomposition engine 112 in order to decompose a spreadsheet into its constituent objects, in accordance with one embodiment of the invention. Referring to FIG. 3, at block 300 the spreadsheet file 202 is read. For example, the file 202 may be in the .xls format. At block 302 the file 202 is marked up in accordance with a mark up language so that the semantic structures in the file 202 are identified. For example, in one embodiment, the particular operations performed at block 302 include converting the file 202 to the Extensible Markup Language (XML) format using Application Programming Interface (API) calls native to the spreadsheet program associated with the file format of the file 200. The operations of blocks 300 and 302 may be performed by a parser 114 of the decomposition engine 112. At block 304; the engine 112 extracts the spreadsheet objects by parsing the XML format. At block 306, the extracted objects are saved or committed as database objects in a database 116 (see FIG. 1). For interfacing with the database 112 the architecture 100 may include a database manager 118. The database manager 118 may include a save function 120 to save objects to the database 116 and a query function 122 to formulate queries to extract data from the database 116. In one embodiment, the query function may generate queried in a query language such as the Structured Query Language (SQL). The database may be implemented as any commercially available relational database.

One skilled in the art would appreciate that the decomposition engine 112 may be used as a re-composition engine to recompose a spreadsheet based on its schema and constituent spreadsheet objects.

Turning again to FIG. 1 of the drawings, it will be seen that the spreadsheet handler 110 includes a function manager 124 to coordinate the execution of a plurality of spreadsheet functions 126. The spreadsheet functions 126 are capable of manipulating the spreadsheets in the database 116 in a variety of ways. According to different implementations, some of the functions may be offered to a user without charge, whereas some of the functions may be offered on a subscription basis. Although the spreadsheet functions are illustrated as separate from the other components of the handler 110, it should be noted that this is only for ease of description and that some of the spreadsheet functions may actually be implemented elsewhere in the handler 110. For example, one of the spreadsheet functions includes a Save function. In one embodiment, the Save function causes a spreadsheet received from a client computer to be decomposed and saved in the database 116 in the manner described above. In some embodiments the spreadsheet functions may include a Compare function to compare two spreadsheets, a Convert function to convert data in a source spreadsheet to a desired form in a target spreadsheet, and a History function to log change information pertaining to a spreadsheet. Each of these functions will be explained in detail later.

For presentation of spreadsheet information to a user, the architecture 100 includes a presentation manager 128. The presentation manager includes a number of predefined views or pages 130 that allow a user to interact with the spreadsheet service. In one embodiment, the presentation manager includes a spreadsheet renderer 132 that allows a spreadsheet to be rendered in a client browser.

### Convert Function

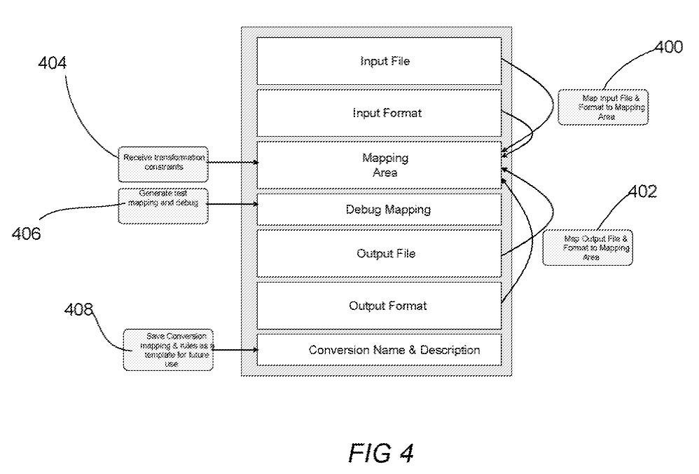

In one embodiment, the convert function may be used to convert data in a source spreadsheet to data in a target spreadsheet. Advantageously, in this embodiment, a user specifies an input file having data representative of data in a source spreadsheet data and an output file having data representative of data in a target spreadsheet and the convert function generates a mapping to transform the data in the input file to the data in the output file. The mapping is then saved as a named conversion (file) so the conversion may be performed on any spreadsheet where it is desired to convert the data in that spreadsheet into data in accordance with the named conversion. The process of generating a named conversion is illustrated in FIG. 4 of the drawings. Referring to FIG. 4, at block 400 the convert function performs a mapping operation to map an input file and format to a mapping area. The input file may be user-selected from the database 116 or uploaded just for the conversion process. In one embodiment, the input format comprises a user-input name for the input format so that the input format may be re-used. The input format may also comprise cell references of the cells in the input file that contain header information and the cells that contain actual data. The mapping area is an area of a screen that the user sees and to which the mapping operation transfers the content of the cell references specified in the input format. At block 402, the convert function performs a mapping operation to map an output file and format to the mapping area. The output file may be user-selected from the database 116 or uploaded during the conversion process. The output file format contains similar information as the input file format.

At block 404, the convert function receives transformation constraints from the user. In one embodiment, the transformation constraints are user-defined constraints that a transformation or mapping to transform the data in the input file to data in the output file must satisfy. As such the transformation constraints may include rules for validating the data in the conversion/transformation process. For example, the transformation constraints may include rules for concatenation, case conversion, numerical calculations, etc.

At block 406, the convert function performs a debug operation. In one embodiment, the debug operation comprises performing a test mapping to map or transform the input file to the output file based on the data in the input and output files as well as the transformation constraints. At block, 408, the mapping to map to input file to the output file may be assigned a name and saved. Thus, the mapping may be re-used.

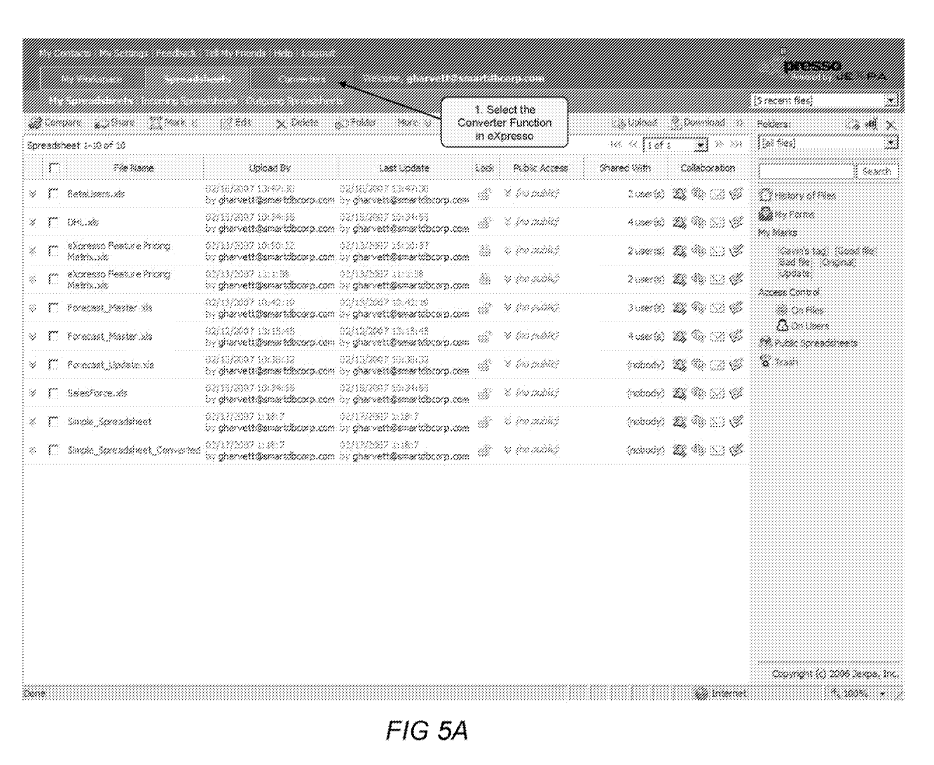

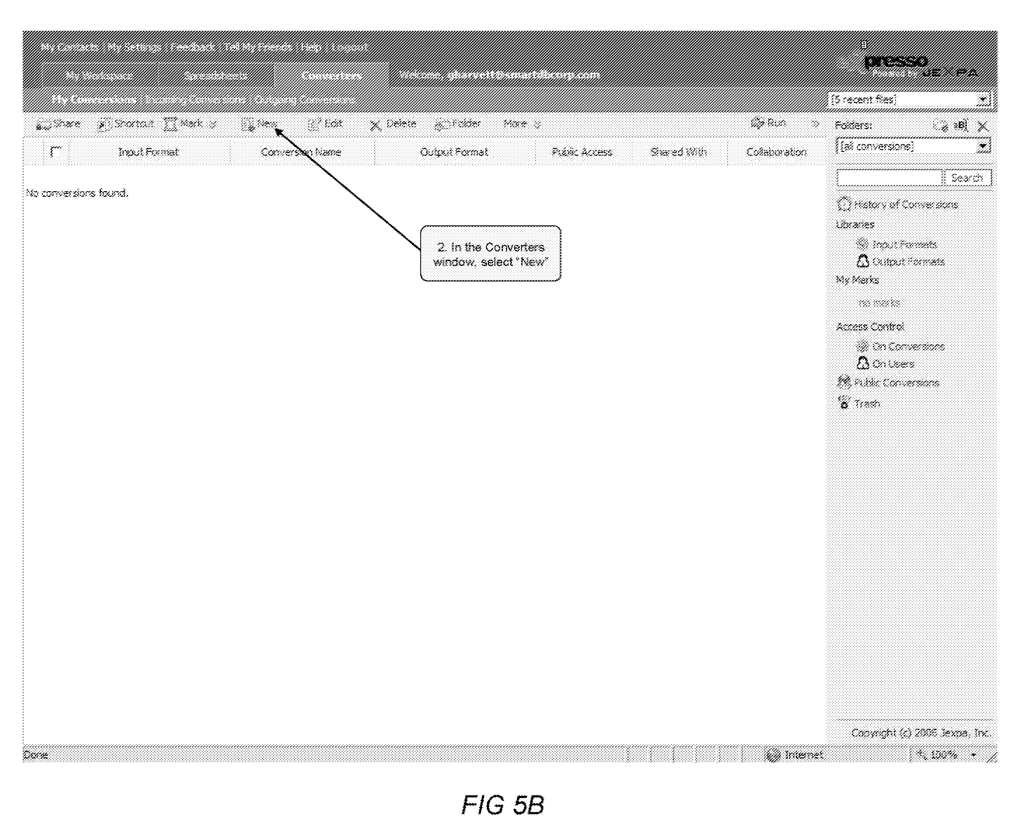

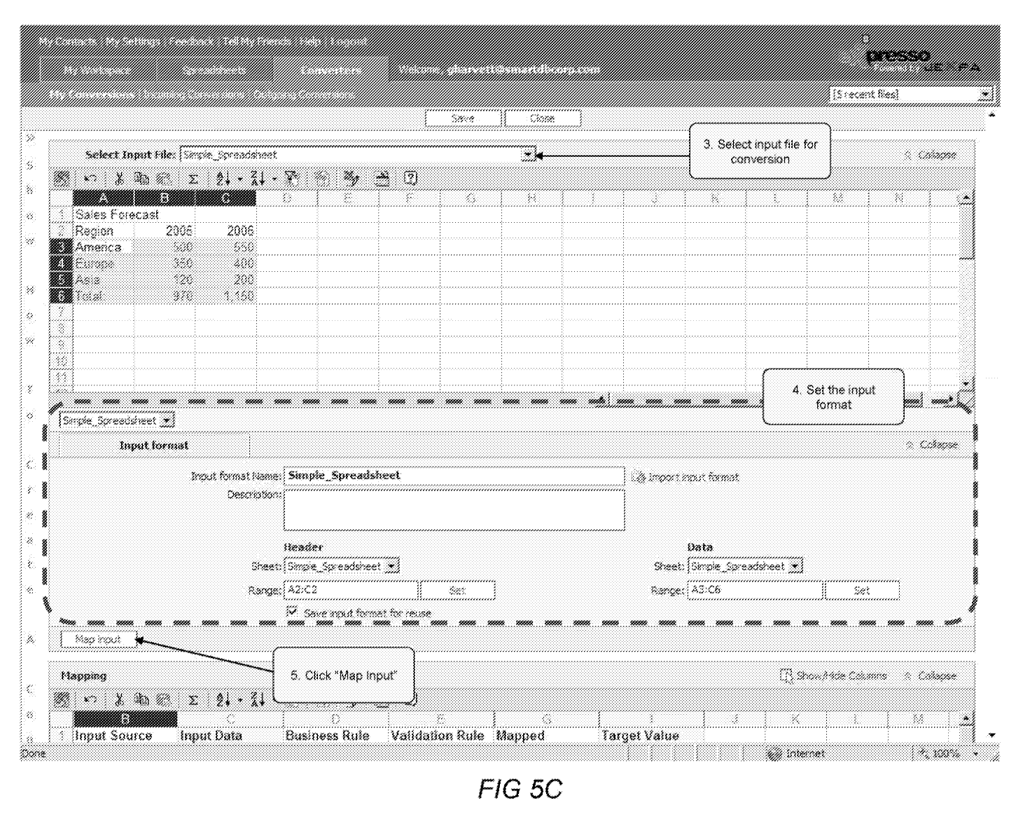

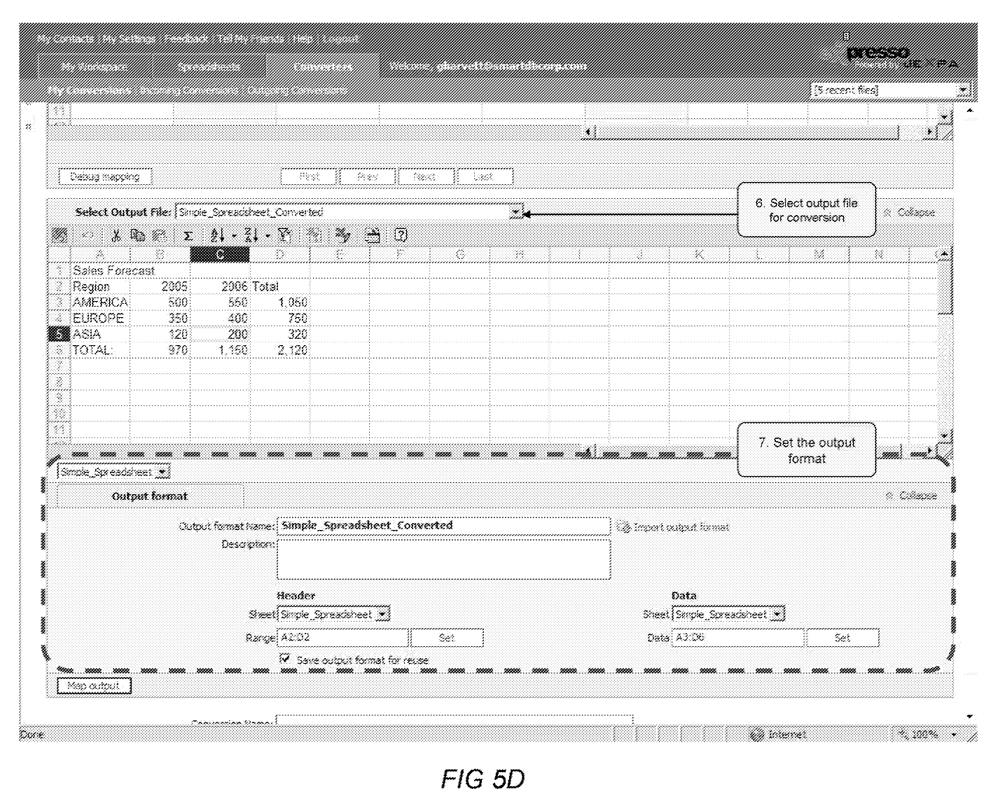

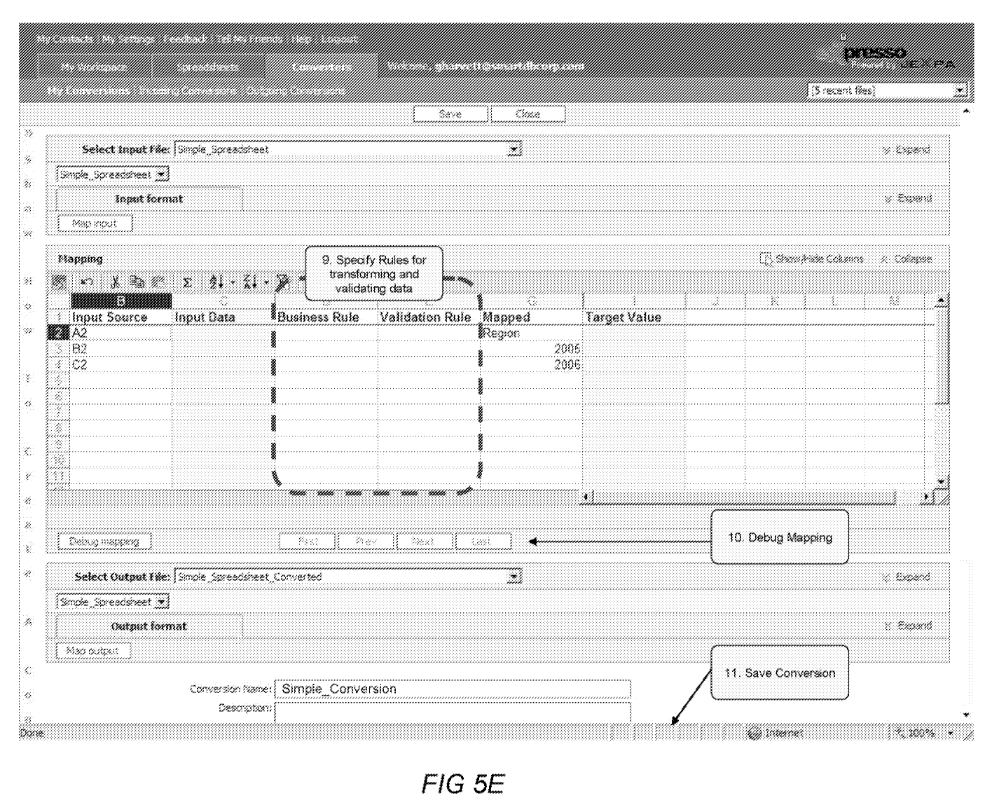

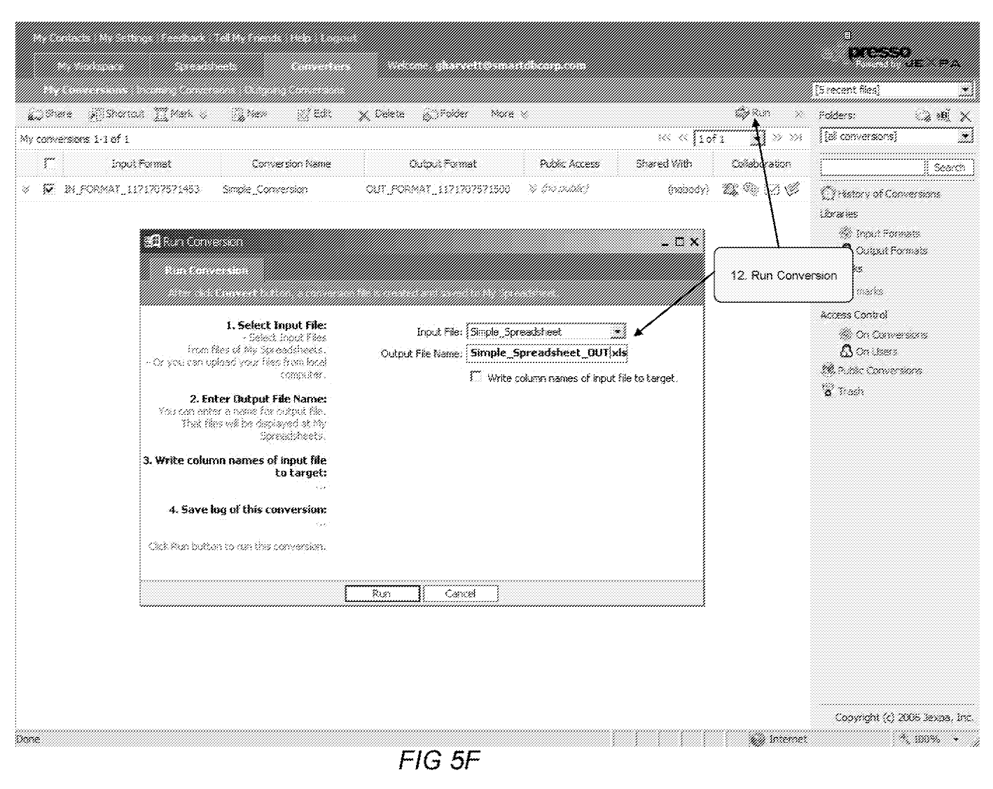

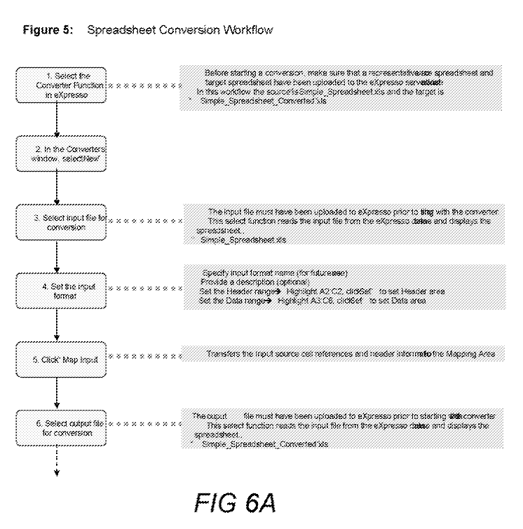

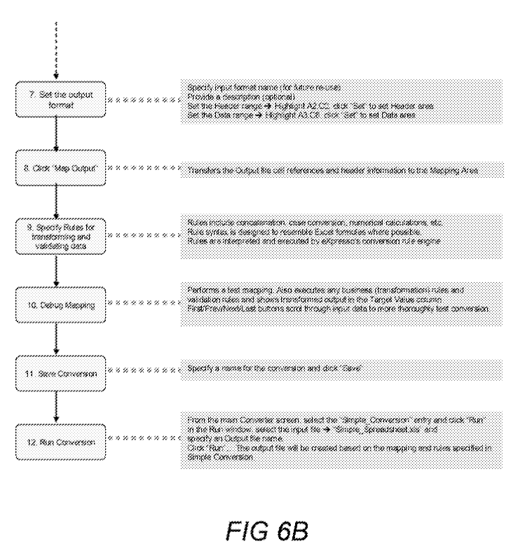

It will be apparent to one skilled in the art that it is possible to implement the above-described convert function using different user-interfaces. Screenshots corresponding to one such graphical user-interface (GUI) is illustrated in FIGS. 5A to 5F. In FIGS. 5A to 5F, twelve steps (referenced as 1 to 12) to create a mapping between a source file and a target file in accordance with the above-described conversion process using the GUI is shown. More detail on the steps 1 to 12 is provided in FIGS. 6A to 6D of the drawings.

### Compare Function

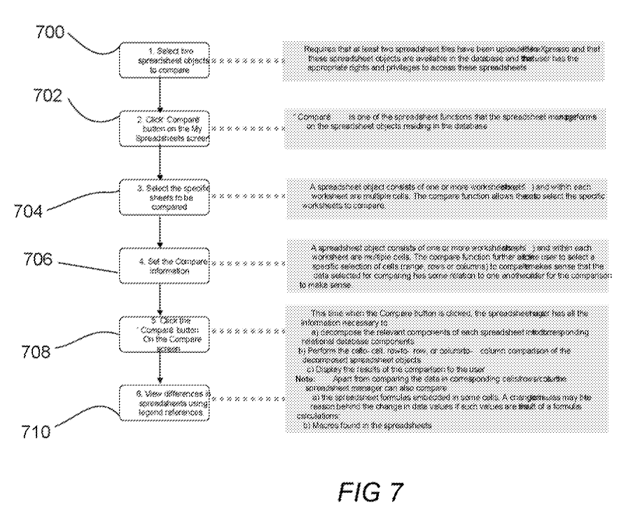

In one embodiment, one of the spreadsheet functions 126 comprises a compare function to compare two spreadsheets and to visually highlight or depict differences between the spreadsheets. A flowchart of operations performed by the compare function in accordance with one embodiment is shown in FIG. 7 of the drawings. Screenshots corresponding to a GUI to facilitate use of the compare function is shown in FIGS. 5A-8C of the drawings. Turning now to FIG. 7, at block 700 the user selects two spreadsheets that the user wishes to have compared with the compare function. At block 702, the user selects or “clicks” a compare button. FIG. 5A shows a screenshot from which it is readily apparent how the user performs operations 700 and 702.

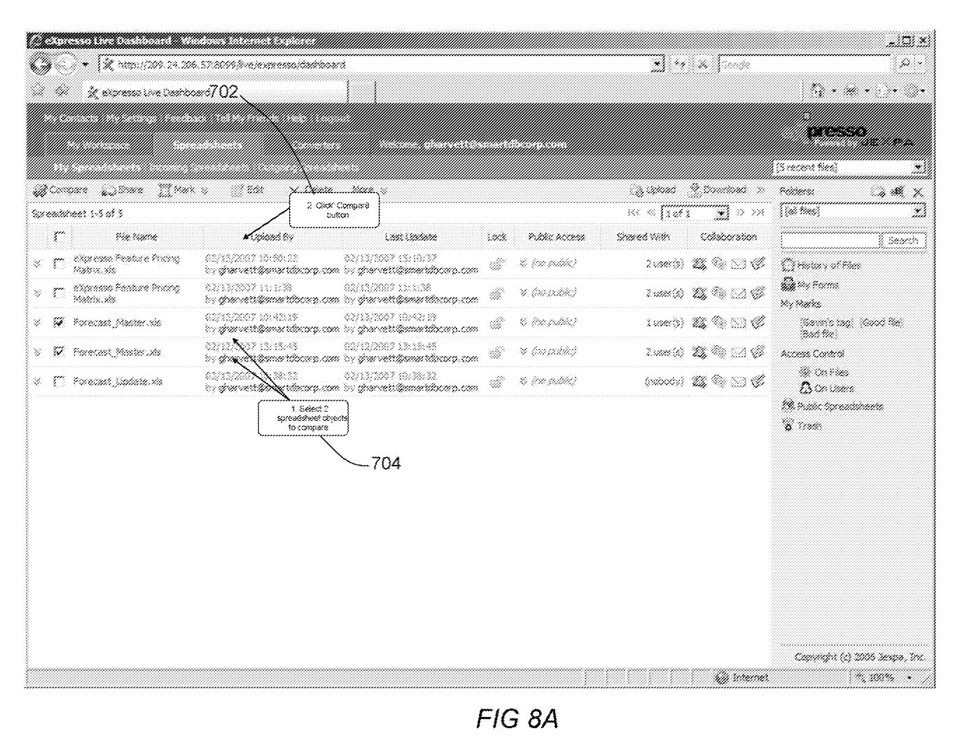

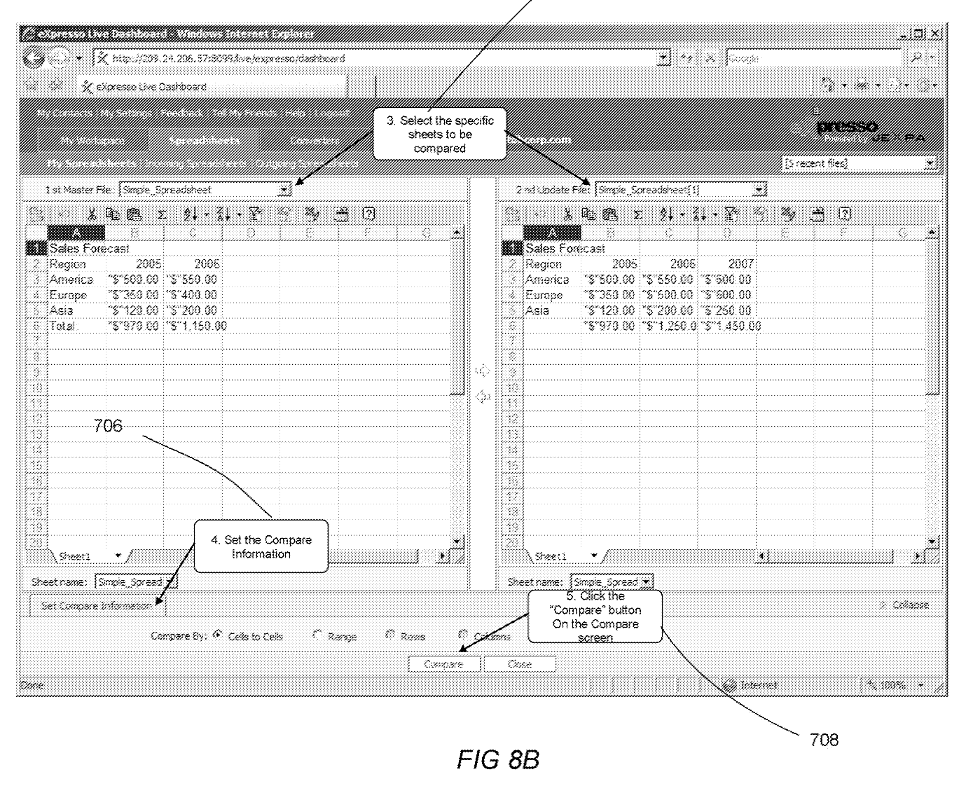

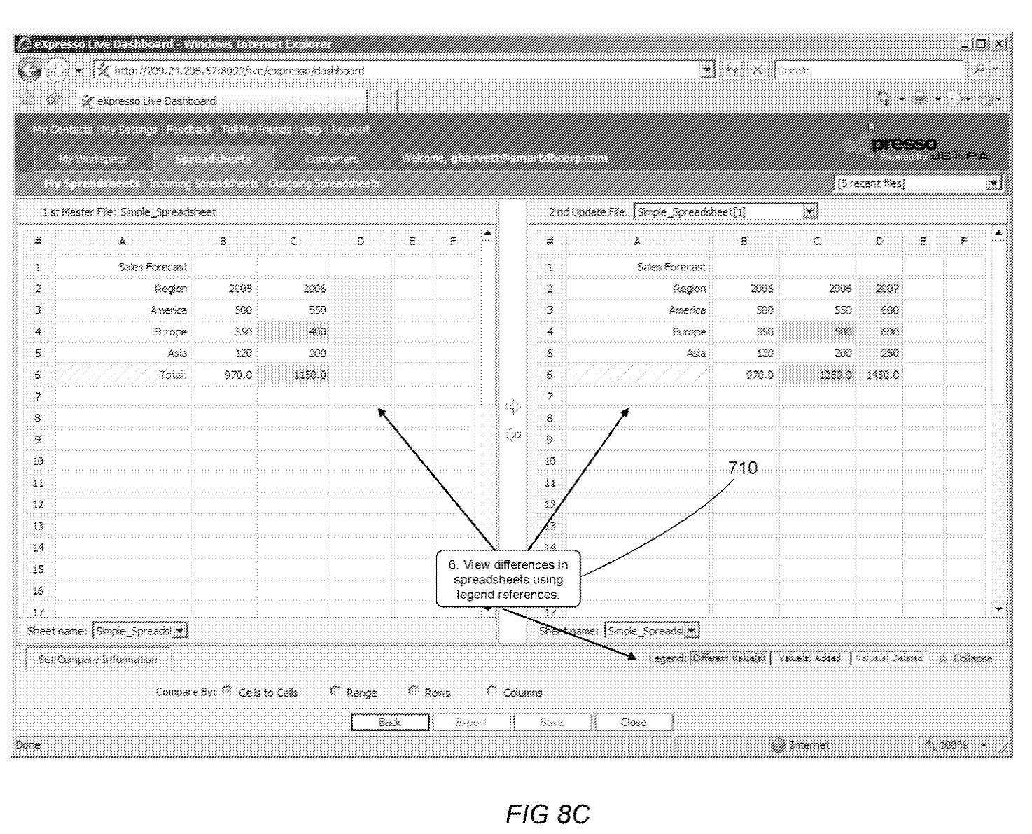

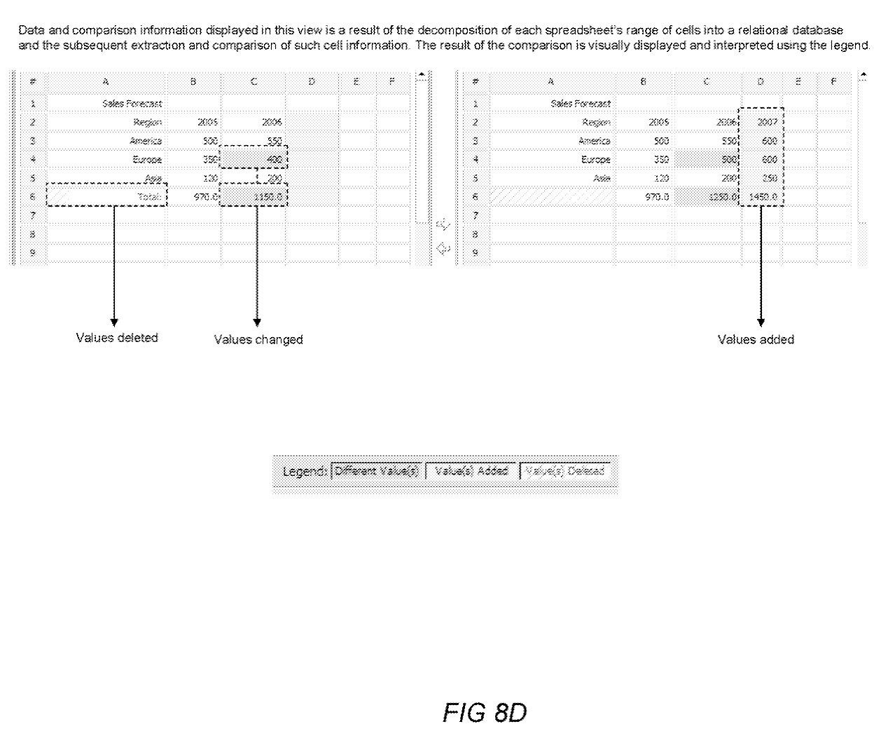

Returning to FIG. 7, at block 704 the user selects the specific worksheets within each spreadsheet to be compared. At block 706, the user sets the compare information. In one embodiment, the compare information comprises the particular cells to be compared specified by range, rows, or columns. FIG. 8B shows a screenshot of a compare screen to facilitate the performance of the operations 704 and 706. At block 708, the user selects a “compare ” button (see FIG. 8B) to cause the compare function to actually perform the comparison between the spreadsheets in accordance with the compare information. At block 710, the user may view differences between the spreadsheets using, for example, legend references. FIGS. 8C and 8D shows a screen shot of what the user sees, in accordance with one embodiment of the invention.

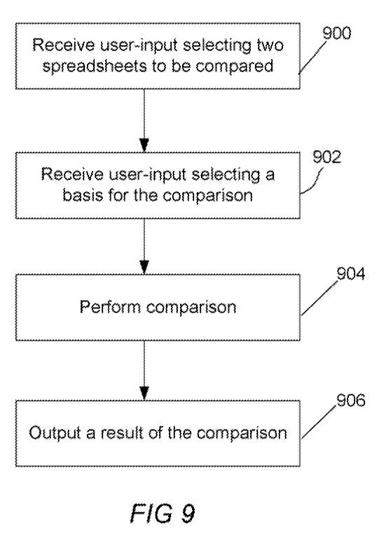

In order to compare two spreadsheets in the manner just described, the convert function performs the operations illustrated in the flowchart of FIG. 9. Referring to FIG. 9, at block 900 the convert function receives user input selecting the two spreadsheets to be compared. At block 902, the convert function receives user input selecting a basis for the comparison. The basis for the comparison includes the particular worksheets and cells to be compared. At block 904, the compare function performs the comparison and, at block 906, outputs a result of the comparison in a format in which differences between the spreadsheets are visually highlighted. It will be appreciated that the differences between the spreadsheets may comprise the addition, deletion, or modification of cells.

### History Function

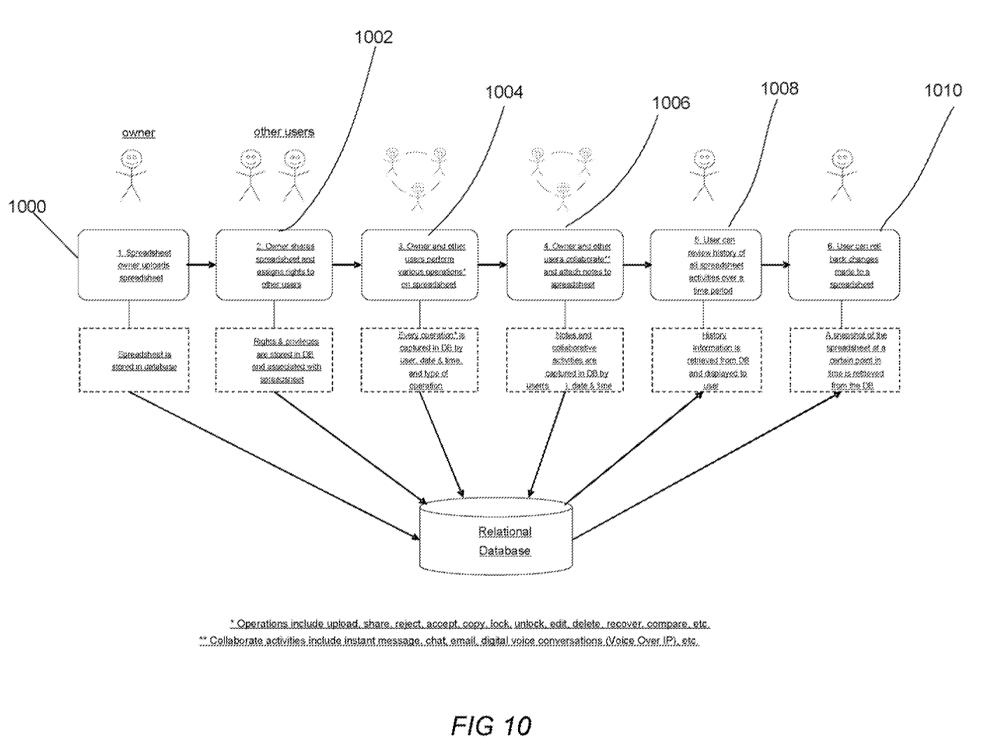

As noted in the background section, it is sometimes difficult to track changes to a spreadsheet given the passage of time. This problem is often compounded where changes to a spreadsheet have been made by more than one person as a result of collaboration. Advantageously, one of the functions implemented by the function manager 124 is a history function which tracks changes to a spreadsheet over a period of time. FIG. 10 illustrates the operation of the history function, in accordance with one embodiment of the invention. Referring to FIG. 10, at block 1000 the user (spreadsheet owner) uploads a spreadsheet into the database 116 in accordance with the techniques described above. At block 1002, the user/owner shares the spreadsheet and assigns rights to other users. At block 1004, the owner and other users with who the spreadsheet is shared may perform various operations on the spreadsheet. These operations may include uploading, sharing, rejecting, copying, locking, unlocking, editing, deleting, recovering, comparing, etc. At block 1006, the spreadsheet owner and the other users may collaborate using the spreadsheet. In one embodiment, collaboration may include such activities as “chatting”, messaging (email), voice conversations, etc. Any of the other users and the spreadsheet owner may create and attach notes relating to the spreadsheet. In one embodiment, the history function captures the notes and the collaborative activities and archives them in the database 116 as a history log associated with the spreadsheet. At block 1008, a user may view the history log. Advantageously, in one embodiment, at block 1010 a user may be able to “roll back” a particular change made to a spreadsheet.

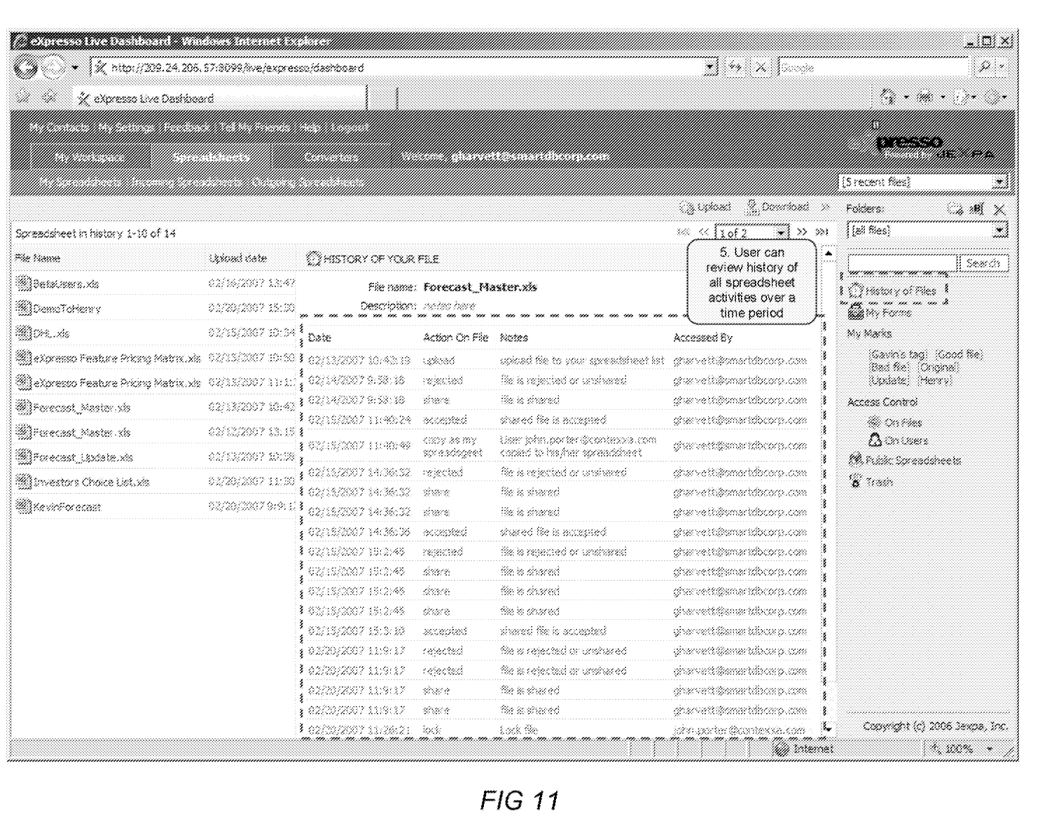

For illustrative purposes, FIG. 11 shows a screenshot in which the history log associated with a particular spreadsheet my be seen.

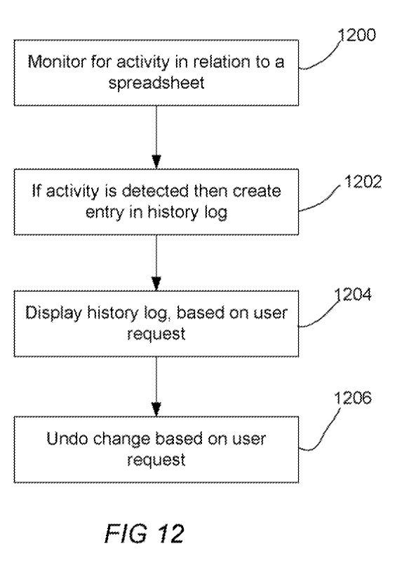

To generate the history log as described above, the history function performs the operations shown in the flowchart of FIG. 12. Referring to FIG. 12, at block 1200, the history monitors for any activity in relation to a spreadsheet. As noted above an activity may comprise creating a note, uploading, sharing, rejecting, copying, locking, unlocking, editing, deleting, recovering, comparing, etc. For each activity detected, the history function generates an entry, at block 1202 in a history log for the spreadsheet. In one embodiment, the entry may comprise a date and time stamp for when the activity occurred, the nature of the activity, the person responsible for the activity, etc. At block 1204, the history function displays the history log to a user responsive to a request to view the history log. At block 1206, the history function undoes or rolls back a change to the spreadsheet based on user input. For example, the history log for a particular spreadsheet may indicate that the spreadsheet was modified on a particular date. If the modification is to be undone, the user may select the entry corresponding to the modification in the history log and select an “Undo” button that would cause the history function to log the “undo” and to restore the spreadsheet to the version before the modification.

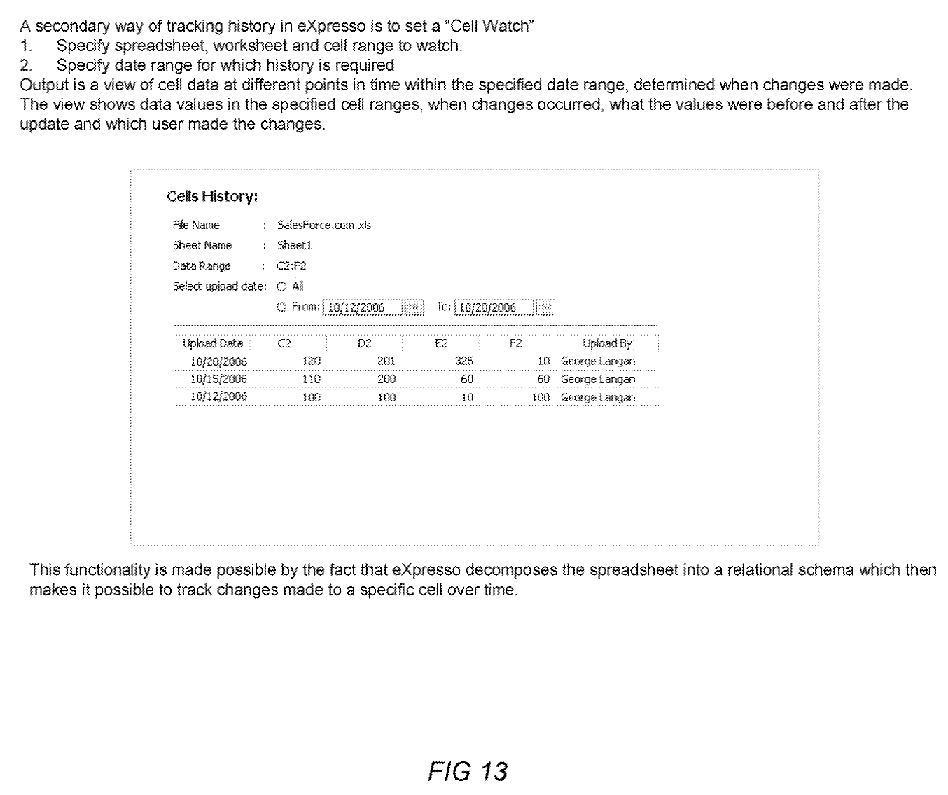

In one embodiment, the history function may implement a “cell watch” function to track changes to a cell or a range of cells. For this embodiment, a user specifies a range of cells to watch from a spreadsheet or a worksheet in a spreadsheet. For the selected cells the user may specify a date range of interest. Responsive to the user selecting the cell and date range as described above the history function outputs a view showing changes to the selected cells at different times within the date range. Thus, the user gets a sense of the historical changes to the cells. FIG. 13 shows the output of the cell watch function, in accordance with one embodiment

FIG. 14 of the drawings shows an example of hardware 1400 that may be used to realize a network server computer implementing the architecture 100, in accordance with one embodiment of the invention. The hardware 1400 typically includes at least one processor 1402 coupled to a memory 1404. The processor 1402 may represent one or more processors (e.g., microprocessors), and the memory 1404 may represent random access memory (RAM) devices comprising a main storage of the hardware 1400, as well as any supplemental levels of memory e.g., cache memories, non-volatile or back-up memories (e.g. programmable or flash memories), read-only memories, etc. In addition, the memory 1404 may be considered to include memory storage physically located elsewhere in the hardware 1400, e.g. any cache memory in the processor 1402 as well as any storage capacity used as a virtual memory, e.g., as stored on a mass storage device 1410.

The hardware 1400 also typically receives a number of inputs and outputs for communicating information externally. For interface with a user or operator, the hardware 1400 may include one or more user input devices 1406 (e.g., a keyboard, a mouse, etc.) and a display 1408 (e.g., a Liquid Crystal Display (LCD) panel).

For additional storage, the hardware 1400 may also include one or more mass storage devices 1410, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 700 may include an interface with one or more networks 1412 (e.g., a local area network (LAN), a wide area network (WAN), a wireless network, and/or the Internet among others) to permit the communication of information with other computers coupled to the networks. It should be appreciated that the hardware 1400 typically includes suitable analog and/or digital interfaces between the processor 1402 and each of the components 1404, 1406, 1408, and 1412 as is well known in the art.

The hardware 1400 operates under the control of an operating system 1414, and executes various computer software applications, components, programs, objects, modules, etc. to implement the web-based spreadsheet service described above. Moreover, various applications, components, programs, objects, etc. may also execute on one or more processors in another computer coupled to the hardware 1400 via a network 1412, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others and transmission type media such as digital and analog communication links.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

1. A method, comprising:
monitoring for activity relating to a spreadsheet;
for each activity detected, generating an entry in a history log for the spreadsheet.

2. The method of claim 1, wherein the spreadsheet is stored in an online database.

3. The method of claim 1, further comprising receiving a request to view the history log from a client computer

4. The method of claim 3, further comprising sending the history log to the client computer responsive to the request.

5. The method of claim 4, wherein the activity is selected from the group of activities comprising creating a note uploading, sharing, rejecting, copying, locking, unlocking, editing, deleting, recovering, and comparing, all of which activities are performed in relation to the spreadsheet.

6. The method of claim 5, further comprising receiving user-input selecting a range of cells from the spreadsheet.

7. The method of claim 6, further comprising receiving user-input selecting a date range.

8. The method of claim 7, further comprising generating code for a graphical user-interface showing each change to the range of cells within the date range.

9. The method of claim 8, further comprising sending the code to the client computer.

10. The method of claim 1, further comprising, responsive to user-input, undoing a change to the spreadsheet corresponding to and entry in the history tog.

11. A system, comprising,
a processor; and
a memory coupled to the processor, the memory storing instructions which when executed by the processor cause the system to perform a method comprising:
monitoring for activity relating to a spreadsheet;
for each activity detected, generating an entry in a history log for the spreadsheet.

12. The system of claim 10, wherein the spreadsheet is stored in an online database.

13. The system of claim 10, wherein the method further comprises receiving a request to view the history log from a client computer

14. The system of claim 13, wherein the method further comprises sending the history log to the client computer responsive to the request.

15. The system of claim 14, wherein the activity is selected from the group of activities comprising creating a note, uploading, sharing, rejecting copying locking unlocking, editing, deleting recovering, and comparing, all of which activities are performed in relation to the spreadsheet.

16. The system of claim 15, wherein the method further comprises receiving user-input selecting a range of cells from the spreadsheet.

17. The system of claim 16, wherein the method further comprises receiving user-input selecting a date range.

18. The system of claim 17, wherein the method further comprises generating code for a graphical user-interface showing each change to the range of cells within the date range.

19. The system of claim 8, wherein the method further comprises presenting a view which the circumstantial information surrounding a spreadsheet can be seen.

20. The system of claim 19, further comprising sending the code to the client computer.
